(19) United States
(12) Patent Application Publication
(10) Pub. No.: US 2024/0308507 A1
(43) Pub. Date: Sep. 19, 2024

(54) METHOD FOR DRIVER ASSISTANCE FOR MOTOR VEHICLES

(71) Applicant: Robert Bosch GmbH, Stuttgart (DE)

(72) Inventor: Stefan Kueperkoch, Heilbronn (DE)

(21) Appl. No.: 18/435,202

(22) Filed: Feb. 7, 2024

(30) Foreign Application Priority Data
Mar. 16, 2023 (DE) 10 2023 202 397.0

(51) Int. Cl. B60W 30/095; B60Q 9/00; B60W 30/16; B60W 30/18; G08G 1/16

(52) U.S. Cl. CPC B60W 30/0956; B60Q 9/008; B60W 30/16; B60W 30/18163; G08G 1/167; B60W 2552/10; B60W 2554/4041; B60W 2554/4042; B60W 2554/4045; B60W 2555/60; B60W 2556/40; B60W 2720/10; B60W 2754/30

(57) ABSTRACT

A method for driver assistance for motor vehicles in a traffic situation in which, when two driving lanes merge, at least one vehicle enters from a merging lane into a driving lane in which another vehicle is driving. In the method, an environment sensor system detects the traffic environment, including the traffic in the merging lane, which allows cooperative behavior of the vehicle in the driving lane.

### CROSS REFERENCE

The present application claims the benefit under 35 U.S.C. § 119 of German Patent Application No. DE 10 2023 202 397.0 filed on Mar. 16, 2023, which is expressly incorporated herein by reference in its entirety.

### FIELD

The present invention relates to a method for driver assistance for motor vehicles in a traffic situation in which, when two driving lanes merge, at least one vehicle enters from a merging lane into a driving lane in which another vehicle is driving, having an environment sensor system for detecting the traffic environment, including the traffic in the merging lane and an adjacent lane.

### BACKGROUND INFORMATION

Methods for driver assistance for motor vehicles in traffic situations are already used in many vehicles today. A basic function of driver assistance functions and automated vehicles is distance control in relation to (slower) vehicles driving ahead (known as ACC: automatic cruise control). Here, vehicles driving ahead are detected by an environment sensor system, for example radar sensors, lidar sensors or video sensors, and the distance from the vehicle driving ahead is calculated. This allows a target distance, i.e., a safety distance, to be calculated and automatically set by accelerating or braking the vehicle in question, which is also referred to as the ego vehicle.

A method and a device for driver assistance is described, for example, in European Patent No. EP 1 758 755 B1. The method for driver assistance for motor vehicles in a traffic situation in which a vehicle changes to an adjacent lane in front of another vehicle is characterized in that, when the driver requests a lane change, a recommendation for the acceleration to be applied to the vehicle or a speed to be reached for the lane change is first displayed based on the data detected by an environment sensor system for detecting the traffic environment, including the traffic in an adjacent lane, and in that a lane change recommendation is then output to the driver if the minimum distance for a lane change from the following vehicle in the adjacent lane is reached without a lane change.

Lane mergers, with which other road users have to merge into the lane of the ego vehicle, are now a particular challenge. Such lane mergers are found at highway on-ramps, for example. In such situations, cooperative behavior on the part of the ego vehicle is desirable: if necessary, the entering vehicle should be given space to cut in in good time. This can be done either by changing lanes to an adjacent lane, if this is free, i.e. not occupied by another vehicle, or by adjusting the speed of the ego vehicle. For this purpose, the ego vehicle is either accelerated or braked in order to give the vehicle in the merging lane enough space to complete the merging process. The problem is that current assistance systems often react too late or not at all to vehicles entering a driving lane from a merging lane, since they usually pay attention only to vehicles in the same lane or in an adjacent lane.

### SUMMARY

A method according to the present invention for driver assistance in motor vehicles in a traffic situation in which, when two driving lanes merge, at least one vehicle enters from a merging lane into a driving lane in which another vehicle, hereinafter referred to as ego vehicle, is driving, allows cooperative behavior of the ego vehicle. According to an example embodiment of the present invention, the method includes the following steps:
A) defining a merge zone on the basis of the driving data of the vehicle in the driving lane and the driving data of the at least one vehicle in the merging lane, wherein the beginning of the merge zone and optionally the course of the merging lane (course of curvature) are determined by the environment sensor system and/or map data in conjunction with locating the vehicle,
B) determining a distance of the at least one vehicle in the merging lane from the merge zone,
C) determining at least one virtual vehicle in the driving lane at a distance from the merge zone, which corresponds to the distance of the at least one vehicle in the merging lane from the merge zone,
D) calculating the anticipated speed course of the at least one vehicle in the merge lane and, from this, a probability of collision between the vehicle in the driving lane and the at least one virtual vehicle prior to reaching the merge zone and in the merge zone,
E) outputting an information signal to the driver of the vehicle in the driving lane and/or automatically adjusting the driving data and/or carrying out a driving maneuver of the vehicle in the driving lane on the basis of the data detected by the environment sensor system in relation to the at least one virtual vehicle in the driving lane and the calculated probability of collision,
F) returning to step B until both driving lanes have merged and either the vehicle in the merging lane has entered the driving lane or the vehicle in the driving lane has passed the merge zone before the vehicle in the merging lane has entered the driving lane.

This method according to an example embodiment of the present invention allows the ego vehicle to react in good time to the vehicle entering the driving lane from the merging lane and thus to make space for the entering vehicle to cut in if necessary.

The information signal that is output to the driver of the ego vehicle can, for example, control an acoustic and/or visual display that signals to the driver an action to be performed, for example braking the ego vehicle, accelerating the ego vehicle or making a lane change.

The information signal can also control a voice output, so that the driver of the ego vehicle is informed of the action to be performed by means of the voice output.

In particular, the information signal can be generated depending on the signals from at least one sensor for monitoring the rear space in the adjacent lane behind the ego vehicle and at least one sensor for monitoring the adjacent lane at the level of the ego vehicle. In this case, it is possible to monitor the traffic behind and to the side of the ego vehicle, for example to signal to the driver to move into the adjacent lane in order to make space for the merging vehicle for its merging process.

In addition to the output of an information signal, the method also provides for automatic adjustment of the driving data of the ego vehicle on the basis of the data detected by the environment sensor system in relation to the at least one virtual vehicle in the driving lane.

According to an example embodiment of the present invention, the driving data of the ego vehicle and the driving data of the at least one virtual vehicle in the driving lane comprise the speed of the ego vehicle and the speed of the at least one virtual vehicle in the driving lane.

The speed of the ego vehicle and the speed of the at least one virtual vehicle in the driving lane are used to determine a probability of collision in the merge zone between the ego vehicle and the at least one virtual vehicle in the driving lane, and the driving data of the ego vehicle are adjusted on the basis of the probability of collision. In the simplest case, a constant speed of the vehicle in the merging lane and the virtual vehicle assigned thereto is assumed here.

Advantageously, the course of the merging lane (in particular, the course of the curvature) and the type of vehicle entering the merging lane (car, truck, motorcycle, . . . ) are used to calculate an anticipated speed course of the at least one vehicle in the merging lane, which corresponds to the speed course of the at least one virtual vehicle.

If there is no probability of collision, for example because the entering vehicle reaches the merge zone after the ego vehicle, the speed of the ego vehicle is not changed. In this case, the ego vehicle drives “through the virtual vehicle,” so to speak, before it reaches the merge zone.

However, if there is a probability of collision in the merge zone, one of the following scenarios is determined:
A lane change to the adjacent lane of the ego vehicle is effected if the environment sensor system determines a sufficiently large gap in the adjacent lane.
If no lane change is possible: the speed of the ego vehicle is adjusted to create or maintain a suitable safety distance from the virtual vehicle in the driving lane.
The speed of the ego vehicle is increased to overtake the virtual vehicle in the driving lane, if this is possible and permitted.
The differential speed between the ego vehicle and the virtual vehicle in the driving lane is limited.

These scenarios effectively prevent collisions between the ego vehicle and the merging vehicle.

Collisions are effectively prevented not only when one vehicle is entering the merging lane, but a plurality of vehicles entering the lane can also be taken into account using this method. In this case, not only one virtual vehicle is determined in the driving lane, but a plurality of vehicles that are driving in the merging lane are projected, so to speak, onto the driving lane of the ego vehicle as virtual vehicles, i.e. a plurality of virtual vehicles are determined in the driving lane of the ego vehicle, so that the ego vehicle can, for example, be adjusted to the center of the gap between these virtual vehicles, in order to allow these vehicles to later cut in to the merge zone.

According to an example embodiment of the present invention, a computer program is configured to carry out each step of the method, in particular when it is executed on a computing device or control unit. It allows the method to be implemented in a conventional electronic control unit without having to make structural changes thereto. For this purpose, it is stored on the machine-readable storage medium. By loading the computer program onto a conventional electronic control device, the electronic control device is obtained, which is configured to control a driver assistance system of a motor vehicle by means of a method of the type described above. This control device can also be implemented as an additional control device.

### BRIEF DESCRIPTION OF THE DRAWINGS

Exemplary embodiments of the present invention are illustrated in the figures and explained in more detail in the following description.

FIG. 1 shows a traffic situation from the related art, in which, by means of the environment sensor system, an ego vehicle detects a vehicle driving ahead in the same lane and provides driver assistance.

FIG. 2 shows a traffic situation in which a vehicle enters a lane of the ego vehicle from a merging lane, wherein the merging vehicle is not used by the ego vehicle for driver assistance.

FIG. 3 shows a traffic situation in which the method according to an example embodiment of the present invention is used.

FIG. 4 shows a traffic situation to illustrate the method according to the present invention with two vehicles in the merging lane.

FIG. 5 shows the general use of the method according to an example embodiment of the present invention even within an arbitrary merge zone (without a separation of lanes) with an anticipated intention for a lane change of a vehicle into the driving lane of the ego vehicle.

FIG. 6 shows a simplified block diagram of a driver assistance system for a vehicle, according to an example embodiment of the present invention.

### DETAILED DESCRIPTION OF EXAMPLE EMBODIMENTS

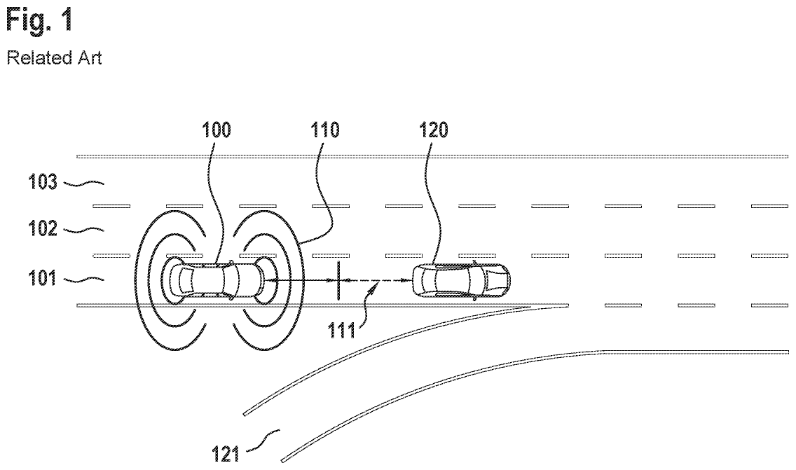

FIG. 1 shows a distance control in relation to slower vehicles driving ahead, which is also known as ACC: automatic cruise control. A roadway has a driving lane 101 in which a vehicle 100, which is hereinafter referred to as an ego vehicle, drives, along with an adjacent lane 102 and a further adjacent lane 103. The ego vehicle 100 has environment sensor system 110 for detecting the traffic environment, including an adjacent lane. This environment sensor system 100 can comprise, for example, radar sensors and/or ultrasonic sensors and/or lidar sensors and/or video sensors and/or camera sensors. The environment sensor system 110 is shown schematically and by way of example in FIG. 1 by signals from a radar sensor. Depending on this environment sensor system 110, the distance of a vehicle 120 driving ahead in the driving lane 101 of the ego vehicle 100 is calculated. This allows a target distance 111, also known as the safety distance, to be calculated and automatically adjusted by accelerating or braking the ego vehicle 100.

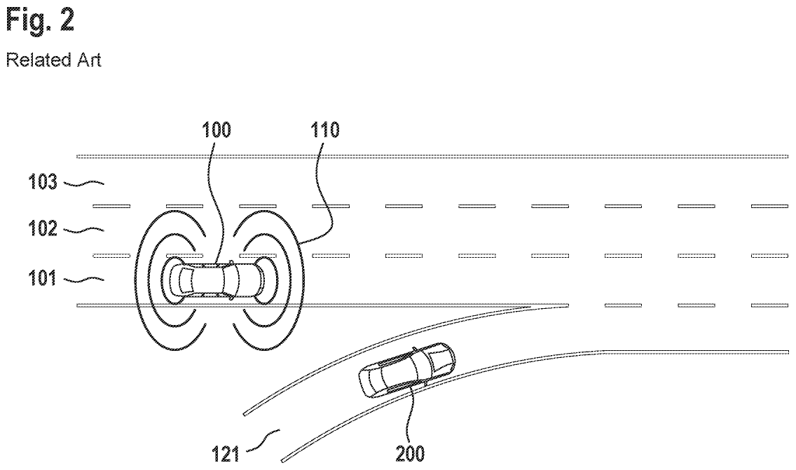

Lane mergers, as shown schematically in FIG. 2, with which other road users have to merge into the lane of the ego vehicle 100, are a particular challenge. Such situations occur at highway on-ramps, for example. An entering vehicle 200 is located in a merging lane 121 and wants to enter the driving lane 101 of the ego vehicle 100. In this case, the environment sensor system 110 of the ego vehicle 100 has not detected the entering vehicle 200 or does not react to it. Cooperative behavior of the ego vehicle 100 would be desirable here: if necessary, it should give the entering vehicle 200 enough space to cut in in good time. This can occur, for example, by a lane change to the adjacent lane 102—if there is a sufficient gap in this lane—or by adjusting the speed of the ego vehicle 100. Adjusting the speed means that the ego vehicle 100 is accelerated or braked in order to provide space for the merging vehicle 200 to cut in.

However, current assistance systems often react too late or not at all to such entering vehicles 200, since they usually pay attention only to vehicles in the same lane 101 or in the adjacent lane 102, but not to vehicles 200 in a merging lane 121, as shown schematically in FIG. 2. Therefore, with lane mergers, for example at highway on-ramps, the ego vehicle 100, which is for example an automated vehicle, should react in good time to entering vehicles 200 in order to give the entering vehicle 200 space to cut in if necessary. This behavior improves cooperation and safety and increases traffic flow and acceptance of the automated driving function.

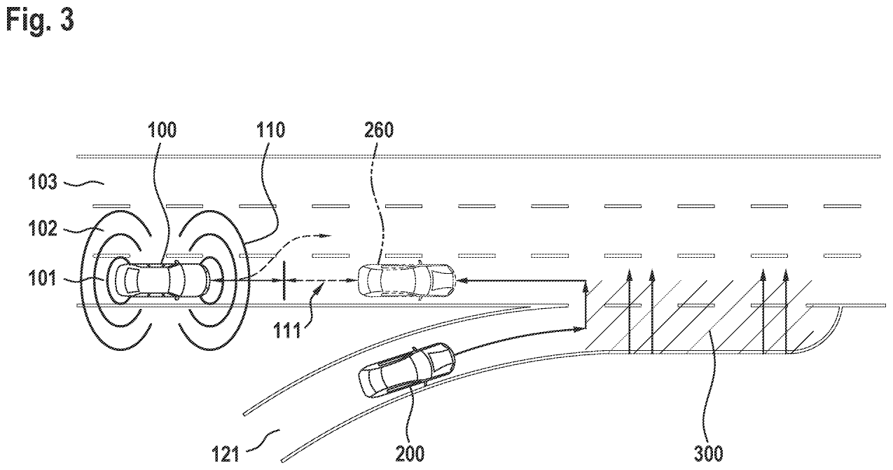

A method that achieves this aim is described below in conjunction with FIG. 3. An ego vehicle 100 in a lane 101 is assumed. A vehicle 200 is located in the merging lane 121. Initially, a merge zone 300 is determined on the basis of the driving data of the ego vehicle 100 and the driving data of the vehicle 200 in the merging lane 121. Driving data means in particular the speed of the ego vehicle 100 and the speed and optionally the vehicle type (car, truck, motorcycle, . . . ) of the vehicle 200 in the merging lane 121. Then, in a further step, the distance s of the vehicle 200 in the merging lane 121 from this merge zone 300 is defined. This distance s is defined in FIG. 3 by the arc length of the arc between the vehicle 200 and the merge zone 300. Optionally, the arc length can be approximated by a secant. In the subsequent next step, a virtual vehicle 260 is determined in the lane 101 of the ego vehicle 100, which is located at a distance from the merge zone 300, which corresponds to the distance s of the vehicle 200 in the merging lane 121 from the merge zone 300. The vehicle 200 in the merging lane 121 is “projected,” so to speak, onto the driving lane 101 of the ego vehicle 100. The result of this “projection” is the virtual vehicle 260, which is now located ahead of the ego vehicle 100 in the lane 101. This virtual vehicle 260 is given the same object properties as the real vehicle 200 in the merging lane 121. This means that the size, type and speed of the virtual vehicle 260 correspond to those of the vehicle 200 in the merging lane 121. In addition, this virtual vehicle 260 receives the information that it is virtual, and the distance s to the merge zone 300 is assigned thereto.

In a further step, an information signal is now output to the driver of the ego vehicle 100 and/or an automatic adjustment of the driving data of the ego vehicle 100 is output on the basis of the data detected by the environment sensor system 110 in relation to the virtual vehicle 260. A return to the first method step is then effected, i.e. the defining of the merge zone 300, and the method is carried out until both driving lanes, i.e. the merging lane 121 and the driving lane 101, have merged, in other words until the merging lane 121 has joined the driving lane 101. In other words, the vehicle 200 in the merging lane 121 is re-projected onto the driving lane 101 in each calculation cycle of the automated ego vehicle 100, so that the projected virtual vehicle 260 moves at the same speed as the vehicle 200 entering the merging lane 121. The automated ego vehicle 100 can now react to this virtual vehicle 260 in good time and initiate the following measures on the basis of its dynamic status and position:

First scenario: If the virtual vehicle 260 is driving slower than the ego vehicle 100 or a virtual collision/overtaking is anticipated to occur prior to reaching the merge zone 300, the ego vehicle 100 is not braked; it drives “through the virtual vehicle 260,” so to speak; in other words, it overtakes the real vehicle 200 in the merging lane 121.

Second scenario: If the virtual vehicle 260 is not driving slower than the ego vehicle 100 or a potential collision is anticipated to occur within the merge zone 300, one of the following steps is initiated:
The ego vehicle 100 switches to the adjacent lane 102 if there is a sufficiently large gap in this lane, which is determined with the aid of the environment sensor system 110 of the ego vehicle 100, which also detects the adjacent lane 102.
Alternatively, a distance control is effected. This means that the driving speed of the ego vehicle 100 is adjusted (increased or decreased) so that a suitable safety distance from the virtual vehicle 260 is established.
A further alternative is to accelerate the ego vehicle, if this is possible and permitted in this situation, in order to overtake the virtual vehicle 260 and increase the distance therefrom.
A further alternative is to limit the differential speed. The ego vehicle 100 overtakes with less speed difference, which makes it easier for the vehicle 200 to adjust its speed to cut in in front of or behind the ego vehicle 100.

In a third scenario, the virtual vehicle drives 260 faster than the ego vehicle. In this case, the relative distance between the virtual vehicle 260 and the ego vehicle 100 increases, which is why the ego vehicle 100 does not have to react in this case.

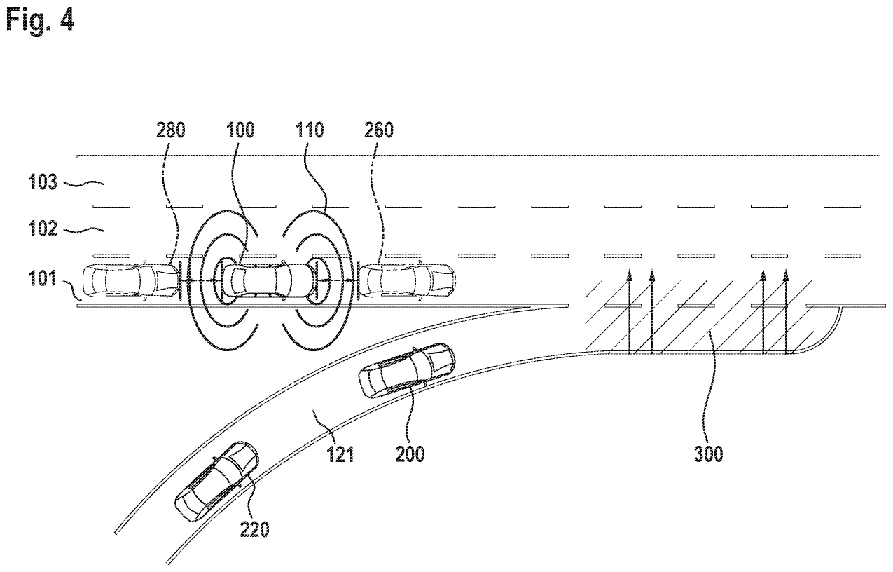

FIG. 4 shows an extension of the method described above. Specifically, a plurality of entering vehicles 200, 220 can also drive in the merging lane 121, which are then projected onto the driving lane 101 of the ego vehicle. In the example shown in FIG. 4, the projected virtual vehicles 260 and 280 are positioned in front of and behind the ego vehicle 100, respectively, so that the ego vehicle 100 can adjust to the center of the gap, for example, in order to allow both vehicles 200, 220 to later cut into the merge zone 300.

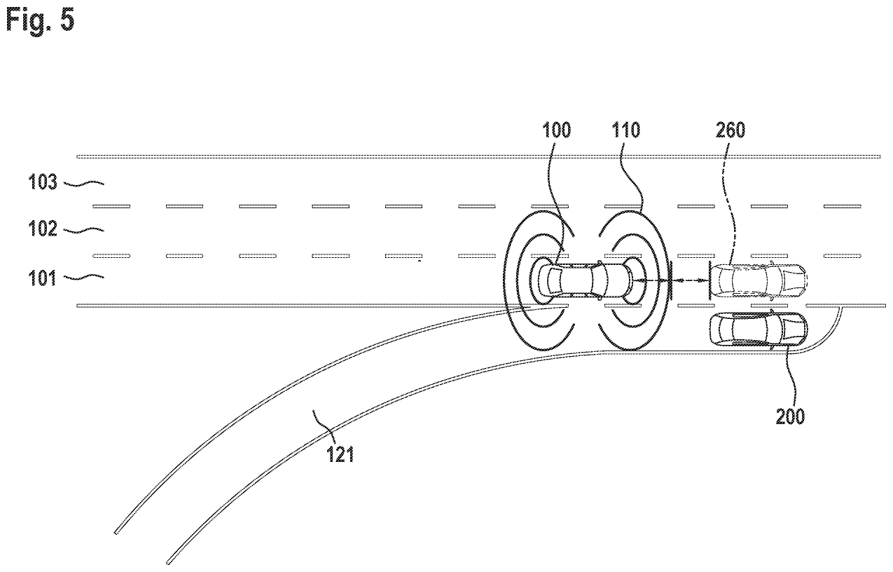

FIG. 5 illustrates the general example in which a vehicle 200 is driving in a lane 121 ahead of the ego vehicle 100, and an intention for this vehicle 200 to change lanes to the lane 101 of the ego vehicle 100 can be predicted or is recognized by the environment sensor system 110, such as a turn signal. Even in this general case, in which there is no separation of the driving lanes, a virtual vehicle 260 can be defined, which is projected, so to speak, onto the adjacent lane at right angles. This virtual vehicle 260 can be taken into account in the assistance systems of the ego vehicle 100. In particular, the method can also be applied to lane changes from both sides of the ego vehicle 100.

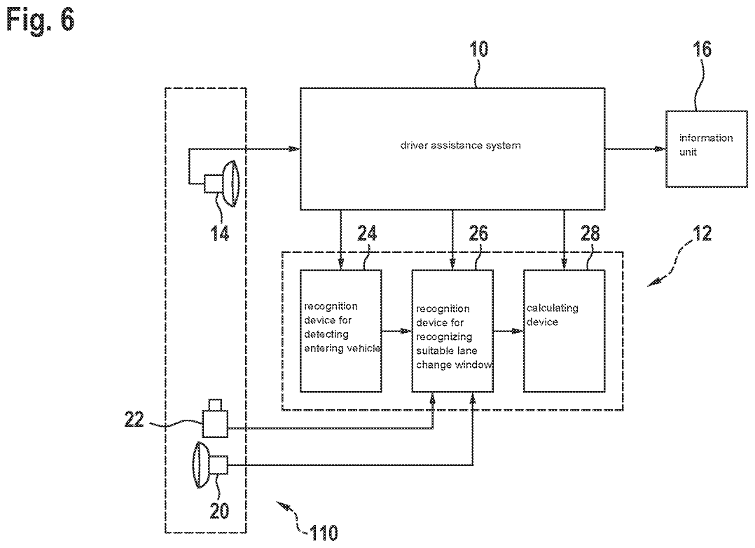

FIG. 6 shows a simplified block diagram of a driver assistance system 10 for a motor vehicle along with a lane change/distance control device 12, which can be part of the driver assistance system 10. The driver assistance system 10 receives signals from at least one sensor 14. This sensor 14 can be realized, for example, by a radar or camera sensor. It controls an information unit 16, via which the driver is notified, for example visually and/or acoustically and/or haptically, about selected driving conditions, such as unintentionally leaving the driving lane, etc. The sensor 14 is part of the environment sensor system 110, which also advantageously includes a rear radar 20 and a short-range sensor 22. It should be noted at this point that a rear sensor system must be present for the automated lane change. However, with a sensor system merely at the front, at least a reduced range of functions can be realized, for example automatic speed adjustment and/or a driver warning. Instead of or in addition to the aforementioned radar/camera sensors, one or more lidar sensors, ultrasonic or imaging radar sensors can be provided, which have a corresponding functionality.

The lane change/distance control device 12 is represented here by three functional blocks, specifically a recognition device 24 for detecting the entering vehicle (including its speed and, optionally, type), recognizing the existence and, advantageously, the course of the merging lane 121, the beginning of the merge zone 300 and, from this, determining whether a collision is occurring within the merge zone 300, an (optional, if automatic lane change is possible) recognition device 26 for recognizing a suitable lane change window in moving traffic in the adjacent lane and a calculation device 28 for calculating a suitable lane change time and for outputting corresponding information and/or for calculating an acceleration or braking strategy and for outputting corresponding acceleration, braking or speed information and, optionally, steering information for an automatic lane change. In practice, the aforementioned functional blocks of the lane change assistant 12 and the driver assistance system 10 can be formed by program modules, which run on a microcomputer or a network of microcomputers and which are part of the driver assistance system 10 or a corresponding control device.

What is claimed is:

1. A method for driver assistance for a motor vehicle in a traffic situation in which, when two driving lanes merge, at least one vehicle enters from a merging lane into a driving lane in which another vehicle is driving, having an environment sensor system for detecting a traffic environment, including the traffic in the merging lane, the method comprising the following steps:
A) determining a merge zone based on driving data of the vehicle in the driving lane and driving data of the at least one vehicle in the merging lane, wherein at least a beginning of the merge zone determined: (i) by the environment sensor system and/or (ii) using map data in conjunction with locating of the vehicle or using traffic sign recognition;
B) determining a distance of the at least one vehicle in the merging lane from the merge zone;
C) defining at least one virtual vehicle in the driving lane at a distance from the merge zone, which corresponds to the distance of the at least one vehicle in the merging lane from the merge zone;
D) calculating an anticipated speed course of the at least one vehicle in the merge lane, wherein the anticipated speed course is used to calculate a speed course of the at least one virtual vehicle, and calculating from the speed course of the at least one virtual vehicle, a probability of collision between the vehicle in the driving lane and the at least one virtual vehicle prior to reaching the merge zone and in the merge zone; and
E) (i) outputting an information signal to the driver of the vehicle in the driving lane, and/or (ii) automatically adjusting the driving data and/or carrying out a driving maneuver of the vehicle in the driving lane, based on data detected by the environment sensor system in relation to the at least one vehicle in the merging lane, the at least one virtual vehicle defined therefrom, and the calculated probability of collision;
F) returning to step B) until the driving lane and the merging lane have merged, and either: (i) the at least one vehicle in the merging lane has entered the driving lane of the vehicle, or (ii) the vehicle in the driving lane has passed the merge zone before the at least one vehicle in the merging lane has entered the driving lane of the vehicle.

2. The method according to claim 1, wherein in step A), a course of curvature of the merging lane is determined: (i) by the environment sensor system and/or (ii) using the map data in conjunction with locating of the vehicle or using the traffic sign recognition.

3. The method according to claim 1, wherein, to detect the traffic environment, the environment sensor system detects the traffic environment of an adjacent lane.

4. The method according to claim 1, wherein the information signal controls an acoustic and/or a visual display.

5. The method according to claim 1, wherein the information signal controls a voice output.

6. The method according to claim 1, wherein the information signal is generated depending on signals of at least one sensor of the environment sensor system for monitoring a rear space in an adjacent lane behind the vehicle in the driving lane and at least one sensor of the environment sensor system for monitoring the adjacent lane at a level of the vehicle in the driving lane and at least one sensor of the environment sensor system for monitoring a front region of the adjacent lane.

7. The method according to claim 1, wherein the driving data of the vehicle in the driving lane and the driving data of the at least one virtual vehicle in the driving lane include a speed and acceleration of the vehicle in the driving lane and a speed and acceleration of the at least one virtual vehicle in the driving lane, wherein driving data of the at least one virtual vehicle are obtained from the driving data of the at least one vehicle in the merging lane.

8. The method according to claim 7, wherein the probability of collision between the vehicle in the driving lane and the at least one virtual vehicle in the driving lane is determined from the speed and the acceleration of the vehicle in the driving lane and a current speed, assumed to be constant, of the at least one virtual vehicle in the driving lane, and the driving data and/or driving maneuvers carried out by the vehicle in the driving lane are adjusted based on the probability of collision.

9. The method according to claim 7, wherein characterized in that a probability of collision between the vehicle in the driving lane and the at least one virtual vehicle in the driving lane is determined from the current speed and an anticipated speed course of the vehicle in the driving lane and the current speed and the anticipated speed course of the at least one vehicle in the merging lane and thus the anticipated speed course of the at least one virtual vehicle in the driving lane, wherein the driving data and/or a driving maneuver carried out by the vehicle in the driving lane are adjusted based on the probability of collision.

10. The method according to claim 9, wherein a course of curvature of the merge zone is determined by the environment sensor system and/or map data in conjunction with locating of the vehicle in the driving lane, and is taken into account in the calculation of the anticipated speed course.

11. The method according to claim 9, wherein information about a vehicle type of the at least one vehicle in the merging lane is recognized by the sensor system and taken into account in the calculation of the anticipated speed course.

12. The method according to claim 8, wherein, when there is no probability of collision, a speed of the vehicle in the driving lane is thus not changed.

13. The method according to claim 8, wherein, when a probability of collision exists, one of the following scenarios occurs:
a lane change to an adjacent lane of the vehicle in the driving lane is effected when the environment sensor system determines a sufficiently large gap in the adjacent lane,
a speed of the vehicle in the driving lane is increased or decreased to achieve or maintain a suitable safety distance from the virtual vehicle driving ahead in the driving lane,
a speed of the vehicle in the driving lane is increased in order to overtake the virtual vehicle driving ahead prior to reaching the merge zone,
a differential speed between the vehicle in the driving lane and the virtual vehicle driving ahead in the driving lane is limited.

14. A non-transitory machine-readable storage medium on which is stored a computer program for driver assistance for a motor vehicle in a traffic situation in which, when two driving lanes merge, at least one vehicle enters from a merging lane into a driving lane in which another vehicle is driving, having an environment sensor system for detecting a traffic environment, including the traffic in the merging lane, the computer program, when executed by an electronic control device, causing the electronic control device to perform the following steps:
A) determining a merge zone based on driving data of the vehicle in the driving lane and driving data of the at least one vehicle in the merging lane, wherein at least a beginning of the merge zone determined: (i) by the environment sensor system and/or (ii) using map data in conjunction with locating of the vehicle or using traffic sign recognition;
B) determining a distance of the at least one vehicle in the merging lane from the merge zone;
C) defining at least one virtual vehicle in the driving lane at a distance from the merge zone, which corresponds to the distance of the at least one vehicle in the merging lane from the merge zone;
D) calculating an anticipated speed course of the at least one vehicle in the merge lane, wherein the anticipated speed course is used to calculate a speed course of the at least one virtual vehicle, and calculating from the speed course of the at least one virtual vehicle, a probability of collision between the vehicle in the driving lane and the at least one virtual vehicle prior to reaching the merge zone and in the merge zone; and
E) (i) outputting an information signal to the driver of the vehicle in the driving lane, and/or (ii) automatically adjusting the driving data and/or carrying out a driving maneuver of the vehicle in the driving lane, based on data detected by the environment sensor system in relation to the at least one vehicle in the merging lane, the at least one virtual vehicle defined therefrom, and the calculated probability of collision;
F) returning to step B) until the driving lane and the merging lane have merged, and either: (i) the at least one vehicle in the merging lane has entered the driving lane of the vehicle, or (ii) the vehicle in the driving lane has passed the merge zone before the at least one vehicle in the merging lane has entered the driving lane of the vehicle.

15. An electronic control device, which is configured to control a driver assistance system of a motor vehicle in a traffic situation in which, when two driving lanes merge, at least one vehicle enters from a merging lane into a driving lane in which another vehicle is driving, having an environment sensor system for detecting a traffic environment, including the traffic in the merging lane, the electronic control device being configured to:
A) determine a merge zone based on driving data of the vehicle in the driving lane and driving data of the at least one vehicle in the merging lane, wherein at least a beginning of the merge zone determined: (i) by the environment sensor system and/or (ii) using map data in conjunction with locating of the vehicle or using traffic sign recognition;
B) determine a distance of the at least one vehicle in the merging lane from the merge zone;
C) define at least one virtual vehicle in the driving lane at a distance from the merge zone, which corresponds to the distance of the at least one vehicle in the merging lane from the merge zone;
D) calculate an anticipated speed course of the at least one vehicle in the merge lane, wherein the anticipated speed course is used to calculate a speed course of the at least one virtual vehicle, and calculate from the speed course of the at least one virtual vehicle, a probability of collision between the vehicle in the driving lane and the at least one virtual vehicle prior to reaching the merge zone and in the merge zone; and
E) (i) output an information signal to the driver of the vehicle in the driving lane, and/or (ii) automatically adjust the driving data and/or carrying out a driving maneuver of the vehicle in the driving lane, based on data detected by the environment sensor system in relation to the at least one vehicle in the merging lane, the at least one virtual vehicle defined therefrom, and the calculated probability of collision;
F) return to B) until the driving lane and the merging lane have merged, and either: (i) the at least one vehicle in the merging lane has entered the driving lane of the vehicle, or (ii) the vehicle in the driving lane has passed the merge zone before the at least one vehicle in the merging lane has entered the driving lane of the vehicle.
